(19) United States
(12) Patent Application Publication
(10) Pub. No.: US 2018/0089318 A1
(43) Pub. Date: Mar. 29, 2018

(54) TWO-SIDED NETWORK GROWTH OPTIMIZATION IN SOCIAL NETWORKS

(71) Applicant: LinkedIn Corporation, Mountain View, CA (US)

(72) Inventors: Shaunak Chatterjee, Sunnyvale, CA (US); Shilpa Gupta, Mountain View, CA (US); Aastha Jain, Sunnyvale, CA (US); Myunghwan Kim, San Jose, CA (US)

(73) Assignee: LinkedIn Corporation, Mountain View, CA (US)

(21) Appl. No.: 15/275,209

(22) Filed: Sep. 23, 2016

(51) Int. Cl. G06F 17/30; H04L 29/08

(52) U.S. Cl. CPC G06F 17/30867; H04L 67/10; G06F 17/30991; H04L 67/306; H04L 67/22

(57) ABSTRACT

The disclosed embodiments provide a system for facilitating interaction within a social network. During operation, the system identifies a first member of a social network with a first activity level that is lower than a threshold. Next, the system uses the first activity level to boost a score associated with recommending an interaction with the first member to a second member of the social network. The system then uses the boosted score to generate output for modulating subsequent interactions in the social network.

### RELATED APPLICATIONS

The subject matter of this application is related to the subject matter in a co-pending non-provisional application by inventors Shaunak Chatterjee, Shilpa Gupta and Romer Rosales, entitled “Optimization of User Interactions based on Connection Value Scores,” having Ser. No. 14/726,979, and filing date 1 Jun. 2015 (Attorney Docket No. 60352-0094; P1511.LNK.US).

The subject matter of this application is also related to the subject matter in a co-pending non-provisional application by inventors Shaunak Chatterjee, Shilpa Gupta, Aastha Jain, Myunghwan Kim, Souvik Ghosh, Romer Rosales and Deepak Agarwal, entitled “Using Potential Interactions to Improve Subsequent Social Network Activity,” having serial number TO BE ASSIGNED, and filing date TO BE ASSIGNED (Attorney Docket No. LI-P2058.LNK.US).

### BACKGROUND

### Field

The disclosed embodiments relate to social networks. More specifically, the disclosed embodiments relate to techniques for performing two-sided network growth optimization in social networks.

### Related Art

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate business activities such as sales, marketing, and/or recruiting by the individuals and/or organizations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions.

Moreover, the dynamics of social networks may shift as connections among users evolve. For example, a user may add connections within a social network over time. Each new connection may increase the user's interaction with certain parts of the social network and/or decrease the user's interaction with other parts of the social network. Consequently, use of social networks may be improved by mechanisms for characterizing and/or modulating the dynamics among users in the social networks.

### BRIEF DESCRIPTION OF THE FIGURES

FIG. 1 shows a schematic of a system in accordance with the disclosed embodiments.

FIG. 2 shows a system for facilitating interaction within a social network in accordance with the disclosed embodiments.

FIG. 3 shows the use of a potential interaction between two members of a social network in modulating subsequent interactions between the two members in the social network in accordance with the disclosed embodiments.

FIG. 4 shows the use of member activity levels to modulate subsequent interactions in a social network in accordance with the disclosed embodiments.

FIG. 5 shows a flowchart illustrating the process of improving interaction in a social network in accordance with the disclosed embodiments.

FIG. 6 shows a flowchart illustrating the process of using member activity levels to modulate subsequent interactions in a social network in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

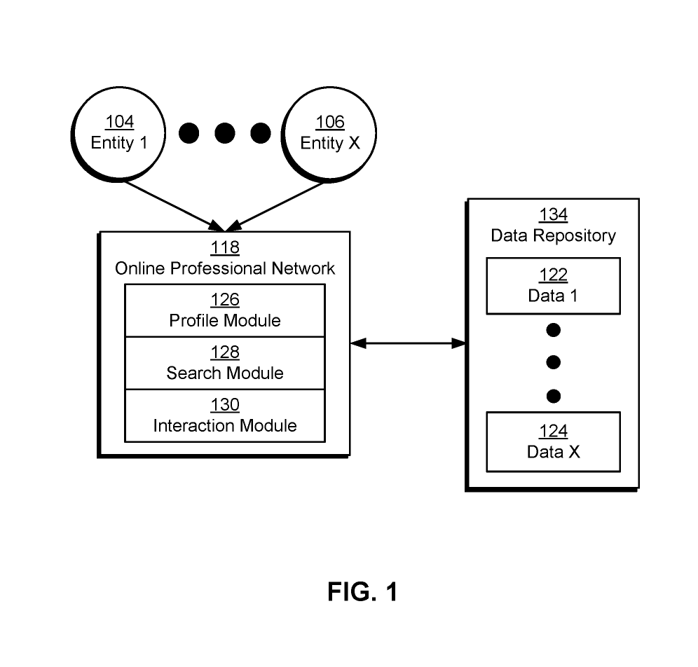

The disclosed embodiments provide a method, apparatus, and system for facilitating interaction within a social network. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. The profile module may also allow the entities to view the profiles of other entities in the online professional network.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in the online professional network to search for profiles, jobs, and/or information by categories such as first name, last name, title, company, school, location, interests, relationship, industry, groups, salary, experience level, etc.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or content feed that provides the latest postings, articles, and/or updates from the entities' connections and/or groups to the entities. Similarly, the online professional network may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing the data repository.

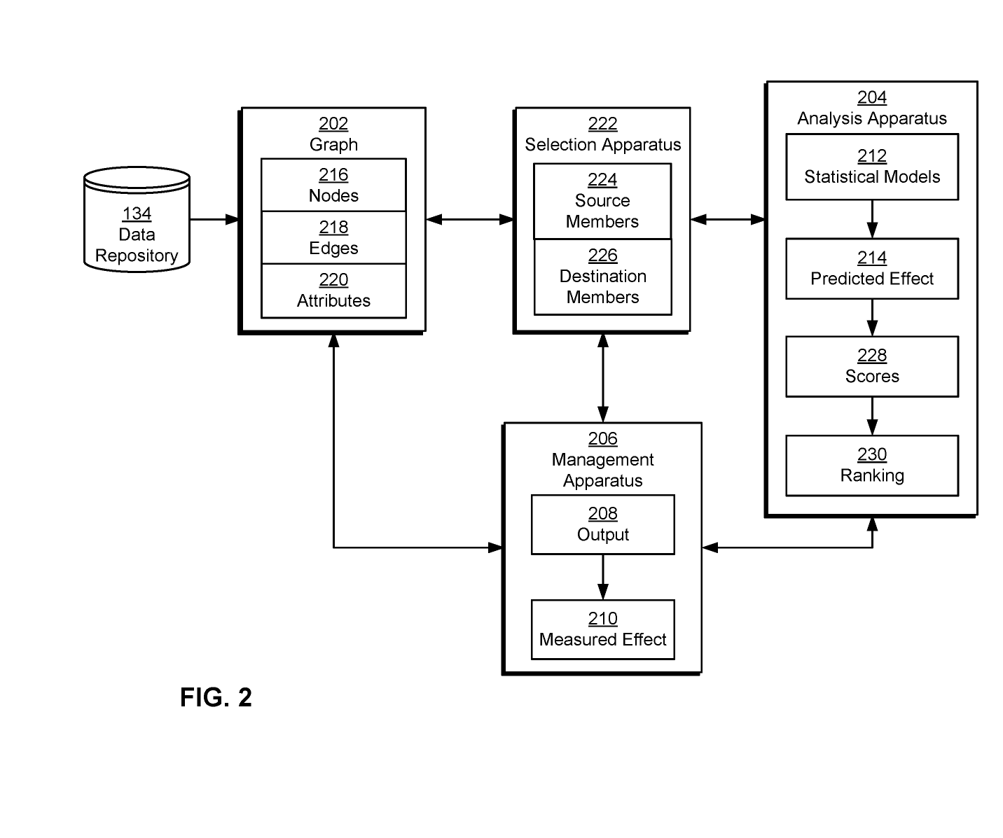

As shown in FIG. 2, data in data repository 134 may be used to form a graph 202 representing the entities, the entities' relationships, and/or the entities' activities in a social network such as online professional network 118 of FIG. 1. Graph 202 may include a set of nodes 216, a set of edges 218, and a set of attributes 220.

Nodes 216 in graph 202 may represent entities in the online professional network. For example, the entities represented by the nodes may include individual members (e.g., users) of the social network, groups joined by the members, and/or organizations such as schools and companies. The nodes may also, or instead, represent other objects and/or data in the social network, such as industries, locations, posts, articles, multimedia, job listings, ads, and/or messages.

Edges 218 may represent relationships and/or interaction between pairs of nodes 216 in graph 202. For example, the edges may be directed and/or undirected edges that specify connections between pairs of members, education of members at schools, employment of members at companies, following of a member or company by another member, business relationships and/or partnerships between organizations, and/or residence of members at locations. The edges may also indicate interactions between the members, such as creating, viewing, liking, commenting on, or sharing articles or posts; sending messages; viewing profiles; and/or endorsing one another.

Nodes 216 and/or edges 218 may also contain attributes 220 that describe the corresponding entities, interactions, and/or relationships in the social network. For example, a node representing a member may include attributes such as name, username, industry, title, seniority, job function, password, and/or email address. Attributes of the member may also be matched to a number of member segments, with each member segment containing a group of members that share one or more common attributes. An edge representing a connection between the member and another member may have attributes such as a time at which the connection was made, the type of connection (e.g., friend, relative, colleague, classmate, employee, following, etc.), and/or the strength of the connection (e.g., how well the members know one another). An edge representing an interaction between the two members may have attributes such as a time or period in which the interaction occurred, the type of interaction (e.g., profile view, message, interaction with a post, endorsement, connection invitation, etc.), and/or the strength of the interaction (e.g., length of message, number of messages sent over a period of time, sentiment of interaction, etc.).

As a result, graph 202 may be used to generate a number of “views” of the social network. The views may include a relationship view that includes a subset of edges 218 representing relationships (e.g., friendships, professional relationships, family relationships, etc.) within the social network. The views may also include one or more interaction views that include subsets of edges representing specific types of interactions in the social network, such as connection invitations, new connections, profile viewings, messages, feed interactions (e.g., consumption or interaction with posts or updates), and/or endorsements. The views may further be isolated to certain member segments, clusters, and/or other groupings of the members.

In turn, the relationships and interactions modeled by graph 202 may be used to characterize, manage, and improve the relationships and interactions among members of the social network. In particular, a selection apparatus 222 may identify a set of source members 224 and a set of destination members 226 associated with one or more types of potential interactions. For example, the selection apparatus may randomly select one or more subsets of members in the social network for exposure to treatment versions of recommendations, content, data, and/or features in the social network during an A/B test. In another example, the selection apparatus may select the source and/or destination members to belong to certain member segments, clusters, and/or groupings in the social network that are identified as relevant or important to certain types and/or amounts of interactions.

Source members 224 may be selected to be the initiators of certain interactions, and destination members 226 may be selected to be the recipients of the interactions. For example, a source member may be shown a destination member as a potential connection in a “People You May Know” feature in the social network. After viewing the potential connection, the source member may initiate interaction with the destination member by inviting the destination member to connect through the feature. By receiving the invitation, the destination member may act as a recipient of the interaction. The destination member may then complete the interaction by accepting the invitation. In another example, a source member may be shown a feed update (e.g., post, article, status update, etc.) from a destination member in a second-degree network of the source member after a third member that is connected to both members interacts with the feed update. Thus, the source member may initiate interaction with the destination member by interacting with the feed update, messaging the destination member, and/or inviting the destination member to connect, and the destination member may receive the interaction as a result of the displayed feed update.

Source members 224 and destination members 226 may additionally be interchangeable and/or indistinguishable for certain types of interactions. For example, a pair of members may lack a designated source and destination if the directionality of the potential interaction between the members is not important to subsequent analysis or modulation of relationships and interactions in the social network.

Selection apparatus 222 may also generate pairs of members from source members 224 and destination members 226 so that each pair contains a source member and a destination member who have not previously interacted with one another in a given context. For example, a source member may be paired with a destination member to whom the source member is not currently connected within the social network. Alternatively, the source and destination members may be selected based on a lack of one or more specific types of interaction, such as messages, interacting with one another's posts, endorsing one another's skills, and/or viewing one another's profiles.

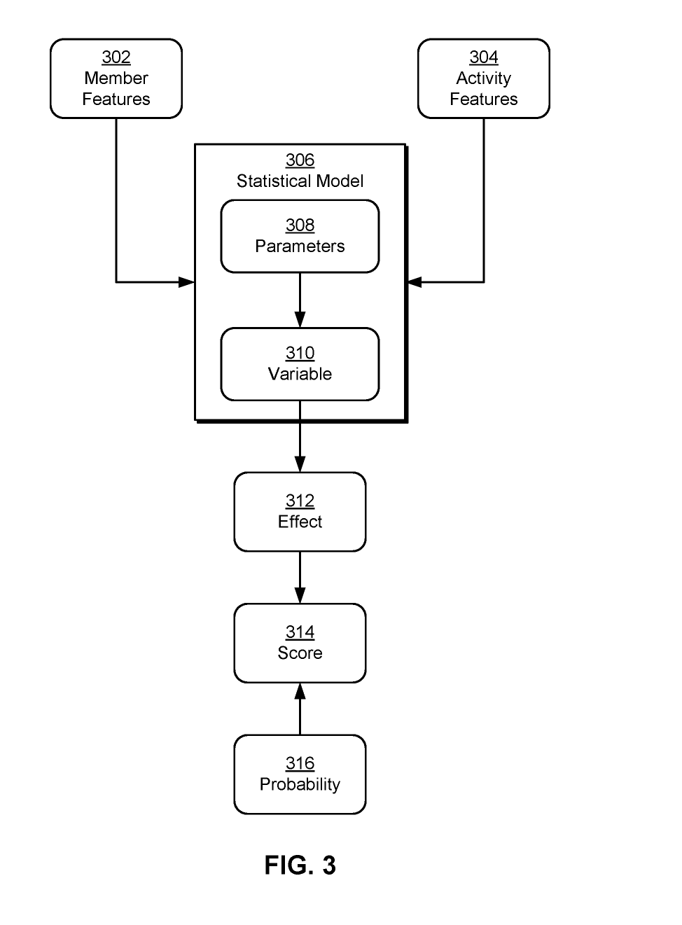

Next, an analysis apparatus 204 may apply one or more statistical models 212 to data associated with each pair of members to produce a predicted effect 214 of a potential interaction between the two members on subsequent interactions in the social network. For example, the analysis apparatus may use one statistical model to predict the effect of a new connection between the two members on feed interactions in the social network. The analysis apparatus may use another model to predict the effect of the new connection on messaging interactions. The predicted effect may include interactions by one member in the pair, both members in the pair, and/or other members in the social network. Using statistical models to predict the effects of interactions within social networks is described in further detail below with respect to FIG. 3.

Predicted effect 214 may include one or more metrics associated with subsequent interactions resulting from the potential interaction. For example, the predicted effect may include the number of feed interactions, messaging interactions, skill endorsements, profile views, job posting interactions, and/or other types of interactions resulting from the potential interaction between the two members. The predicted effect may also, or instead, include the likelihood of each type of feed interaction occurring between the two members given the potential interaction.

Analysis apparatus 204 may use predicted effect 214 to produce a set of scores 228 for multiple pairs of members from selection apparatus 222. For example, the analysis apparatus may combine one or more predicted effects (e.g., likelihood or number of feed interactions, messaging interactions, and/or other types of subsequent interactions) of a potential interaction between two members with an estimated probability of the potential interaction to generate a score for the potential interaction that is associated with the source member. A higher score may thus represent a higher positive impact of the potential interaction on the subsequent interactions than a lower score. Calculation of the score may be repeated for other destination members with whom the source member is paired.

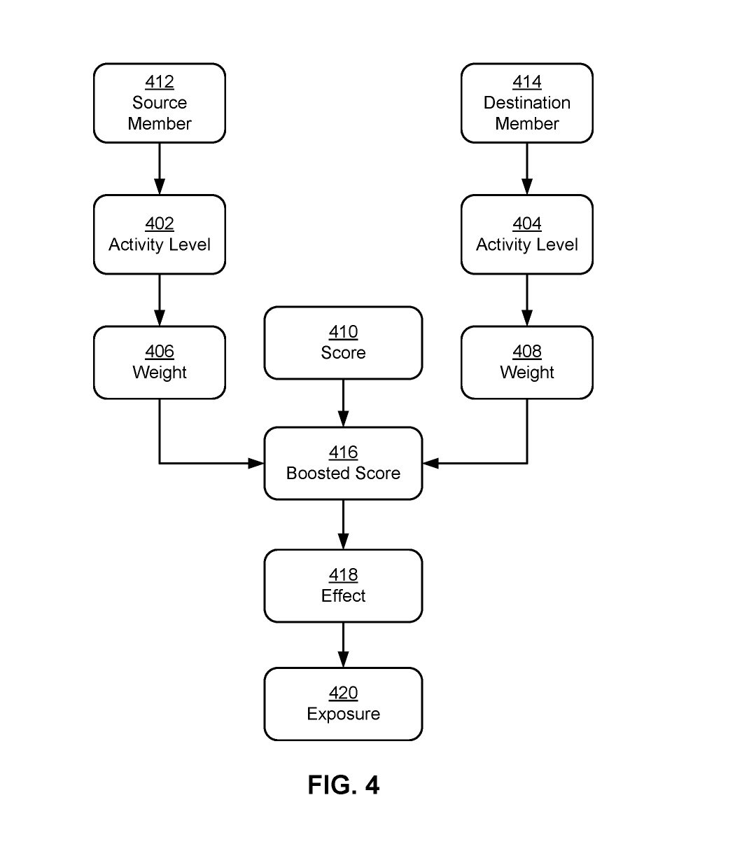

Analysis apparatus 204 may additionally modulate scores 228 based on activity levels of the source and/or destination member in each pair of members, independently of or in conjunction with using predicted effect 214 to calculate the scores. For example, analysis apparatus 204 may boost a score for a new connection between a pair of members if the destination member has a low activity level and/or the source member has a high activity level within the social network. The score may be boosted to increase the visibility of the destination member to the source member. For example, boosting of the score may cause the destination member to be placed and/or appear higher in a list of recommended connections, messaging recipients, content items in a content feed, and/or other features or recommendations in the social network. In turn, the increased visibility may cause the more active source member to initiate an interaction that encourages the destination member to become more active in the social network, thereby improving subsequent interaction in the social network. Using member activity levels to modulate subsequent interactions in a social network is described in further detail below with respect to FIG. 4.

After scores 228 are calculated and/or boosted for a given source member, analysis apparatus 204 may generate a ranking 230 of the potential interactions by the scores. For example, the analysis apparatus may rank the potential interactions members in descending order of score, so that potential interactions with the highest positive impact on subsequent interactions involving the source member are at the top of the ranking. At the same time, boosted scores may improve the position of the corresponding destination members in the ranking.

A management apparatus 206 may then use predicted effect 214, scores 228, and/or ranking 230 to generate output 208 for modulating subsequent interactions in the social network. For example, management apparatus 206 may display a highest-ranked subset of potential interactions from the ranking as recommendations to one or both members involved in the potential interactions. In another example, the management apparatus may display a continuous grid, list, and/or other arrangement of recommendations according to the order specified in the ranking. The recommendations may include new connections, profile views, messages, and/or other types of suggested interaction between the members. The recommendations may be outputted via email, a messaging service, a “People You May Know” feature, and/or an introduction feature on the social network. The management apparatus may also generate non-recommendation-based output for modulating the subsequent interactions, such as showing feed updates associated with a member in a news feed of another member that is not directly connected to the member to encourage interaction between the two members.

Management apparatus 206 may also obtain and/or produce a measured effect 210 associated with output 208 and provide measured effect 210 as feedback that is used to update statistical model 212. For example, measured effect 210 may be determined as the observed number of interactions between two members after the members are connected (e.g., through a connection recommendation in output 208) and/or after one member is shown output 208 containing a feed update associated with the other member. Management apparatus 206 may provide the observed change to analysis apparatus 204, and analysis apparatus 204 may update the parameters of one or more statistical models 212 to better reflect the observed change.

By characterizing the interplay among different types of interactions and users in the social network, the system of FIG. 2 may identify and predict the effects of certain potential interactions and types of potential interactions on subsequent interactions in the social network. In turn, the effects may be used to influence the subsequent interactions and improve use of the social network by the members. For example, the effects may be used to perform multi-objective optimization of metrics related to feed interactions, messaging interactions, profile views, connection invitations, new connections, endorsements, job applications, and/or other types of interaction or network growth in the social network.

Those skilled in the art will appreciate that the system of FIG. 2 may be implemented in a variety of ways. First, analysis apparatus 204, management apparatus 206, selection apparatus 222, and/or data repository 134 may be provided by a single physical machine, multiple computer systems, one or more virtual machines, a grid, one or more databases, one or more filesystems, and/or a cloud computing system. Analysis apparatus 204, management apparatus 206, and selection apparatus 222 may additionally be implemented together and/or separately by one or more hardware and/or software components and/or layers.

Second, a number of statistical models 212 and/or techniques may be used to generate predicted effect 214. For example, the functionality of each statistical model may be provided by a logistic regression model, Poisson regression model, artificial neural network, support vector machine, decision tree, naïve Bayes classifier, Bayesian network, clustering technique, hierarchical model, and/or ensemble model. Moreover, the same statistical model or separate statistical models may be used to generate the predicted effect for various source members 224, destination members 226, member segments, attributes 220, connections, and/or interactions in the social network. For example, a separate statistical model may be used to characterize and predict changes in the interactions and/or relationships of a different member and/or member segment of the social network. In another example, multiple statistical models may be used to model and modulate different types of interactions (e.g., profile views, feed interactions, active interactions, new connections, etc.) in the social network.

FIG. 3 shows the use of a potential interaction between two members of a social network in modulating subsequent interactions between the two members in the social network in accordance with the disclosed embodiments. As mentioned above, a statistical model 306 (e.g., from statistical models 212 of FIG. 2) may be used to predict an effect 312 of the potential interaction on the subsequent interactions. The effect may be generated using member features 302 and activity features 304 of both members.

Member features 302 may include profile attributes from the members' profiles with the social network, such as each member's title, skills, work experience, education, seniority, industry, location, and/or profile completeness. The member features may also include the member's number of connections in the social network, the member's tenure on the social network, and/or other metrics related to the member's overall interaction or “footprint” in the social network. The member features may also include attributes that are specific to one or more features in the social network, such as a classification of the member as a job seeker or non-job-seeker in an online professional network.

Activity features 304 may characterize the recent activity of the members. For example, the activity features may include an activity level of each member, which may be binary (e.g., dormant or active) or calculated by aggregating different types of activities into an overall activity count and/or a bucketized activity score. The activity features may also include attributes (e.g., activity frequency, dormancy, etc.) related to specific types of social network activity, such as messaging activity (e.g., sending messages within the social network), publishing activity (e.g., publishing posts or articles in the social network), mobile activity (e.g., accessing the social network through a mobile device), and/or email activity (e.g., accessing the social network through email or email notifications).

One or more activity features 304 may further be combined into a derived feature such as a cross product, cosine similarity, statistic, and/or other transformation of existing activity features. For example, separate binary activity levels for the members may be used to generate a combined feature for both members that has four possible values (e.g., active-active, active-dormant, dormant-active, dormant-dormant).

Member features 302 and activity features 304 may be provided as input for estimating one or more parameters 308 of statistical model 306. For example, parameters 308 may be identified by regressing on a feature vector containing the member and activity features. After the parameters are estimated, the statistical model may be used to generate a value of a variable 310 representing effect 312. For example, values of member features 302 and activity features 304 may be combined with parameters of a trained statistical model 306 to produce one or more numeric values representing a number of subsequent interactions between the members and/or a probability of the subsequent interactions occurring given the occurrence of the potential interaction.

Multiple versions of statistical model 306 may additionally be used to predict effect 312 for different types of potential interactions and/or subsequent interactions. For example, different versions of statistical model 306 may be employed for various potential and/or subsequent interactions, such as new connections, messaging interactions, feed interactions, endorsement interactions, profile views, job seeking interactions, and/or other types of activity in the social network.

Effect 312 may then be combined with a probability 316 of the corresponding potential interaction to calculate a score 314 for the potential interaction. For example, the score for the potential interaction may be calculated using the following formula:

Pr(interactionᵢⱼ)*(1+w₁*effect₁+w₂*effect₂+ . . . +wₙ*effectₙ)

In the above formula, Pr(interactionᵢⱼ) represents the estimated probability of a potential interaction (e.g., new connection, feed interaction, etc.) between members i and j. The estimated probability is multiplied by a factor that is the sum of 1 and a weighted combination of various values of effect 312 for different types of interaction (e.g., likelihood or number of feed interactions, messaging interactions, profile view interactions, endorsement interactions, etc.) to produce the score. The score may then be used to generate output for modulating subsequent interaction in the social network, as described above.

In one or more embodiments, the above formula is used to estimate a “connection value score” representing a value of a connection between the two members. The connection value score may be calculated after the connection is made from measurements of different types of interactions between the members. As a result, the weight associated with a given type of interaction may reflect the contribution of the type of interaction to the connection value score. Weighting of interaction types during calculating of connection value scores in social networks is described in a co-pending non-provisional application by inventors Shaunak Chatterjee, Shilpa Gupta and Romer Rosales, entitled “Optimization of User Interaction based on Connection Value Scores,” having Ser. No. 14/726,979, and filing date 1 Jun. 2015 (Attorney Docket No. 60352-0094; P1511.LNK.US), which is incorporated herein by reference.

FIG. 4 shows the use of member activity levels 402-404 to modulate subsequent interactions in a social network in accordance with the disclosed embodiments. Activity level 402 may be associated with a source member 412, and activity level 404 may be associated with a destination member 414. The source and destination members may be selected based on the corresponding activity levels and/or the member segments of one or both members. For example, the destination member may be selected to have an activity level that is lower than a threshold for a given member segment to which the destination member belongs, and the source member may be selected to have an activity level that is higher than the activity level of the destination member and/or another threshold. In another example, the source and destination members may be selected from the same member segment or different member segments based on characterized or desired interactions within or across member segments of the social network.

Next, a boosted score 416 associated with recommending to source member 412 an interaction with destination member 414 is calculated by combining an original score 410 for the recommended interaction with a combination of activity levels 402-404 and corresponding weights 406-408. For example, the boosted score may be calculated using the following:

score*(1+w_{src}*activity_{src}+w_{dest}*activity_{dest})

In other words, the boosted score may be calculated by scaling the original score by the sum of 1, a Boolean or numeric activity level 402 (i.e., activay_{src}) multiplied by weight 406 (i.e., w_{src}), and a Boolean or numeric activity level 404 (i.e., activity_{dest}) multiplied by weight 408 (i.e., w_{dest}). The original score may be obtained as score 314 or probability 316 using the process of FIG. 3 and/or as another measurement of value associated with the recommended interaction. The weights may be set to reflect the possible values of the corresponding activity levels, the range of acceptable values for the original score, and/or the amount of boosting to be provided with each activity level.

Boosted score 416 may then be used to generate output for modulating subsequent interactions in the social network. For example, boosted score 416 may increase the position of destination member 414 in a ranking of potential connections for source member 412, resulting in the display of the destination member as a recommended connection to source member 412 when the original score 410 would have precluded or delayed display of the destination member to the source member. The displayed recommendation may prompt the source member to send a connection invitation to the destination member and encourage the destination member to visit the social network, which may increase activity level 404 for the destination member. On the other hand, the display of the destination member and/or other destination members with boosted scores to the source member may displace other recommendations that may be more relevant to the source member, thereby decreasing the overall number of connection invitations sent by the source member.

An effect 418 of the boosted score may be tracked to characterize the tradeoff between an increase in activity level 404 for destination member 414 and a decrease in certain types of interaction for source member 412. For example, the effect may identify the amount by which a recommendation to form a new connection between the two members increases the activity level of the destination member and decreases the number of connection invitations from the source member.

Effect 418 may then be used to adjust a subsequent exposure 420 of other members of the social network to the boosted score. For example, source member 412 and destination member 414 may be selected for exposure to the boosted score in an A/B test. The source member may be included in a treatment group of source members that are exposed to boosted scores of destination members, and the destination member may be included in a treatment group of destination members for which scores are to be boosted. The proportion of source members assigned to treatment may be smaller than the proportion of destination members assigned to treatment to mitigate the potentially negative effect of the boosted scores on the source members' subsequent interactions and/or increase the potentially positive effect of the boosted scores on the destination members' activity levels. The positive and/or negative effect of the boosted scores may then be characterized by extrapolating the effect to large populations of members, and the characterized effect may be used to increase or reduce the number of source and/or destination members to be subsequently exposed to the boosted scores.

Effect 418 and/or exposure 420 may also be modulated by adjusting weights 406-408. For example, one or both weights may be increased or decreased to produce a target percentage change between a ranking that contains potential interactions with boosted scores and a ranking that does not contain potential interactions with boosted scores. An increase in the percentage change may result in a more pronounced effect of and/or exposure to the boosted scores, and a decrease in the percentage change may result in a less pronounced effect of and/or exposure to the boosted scores.

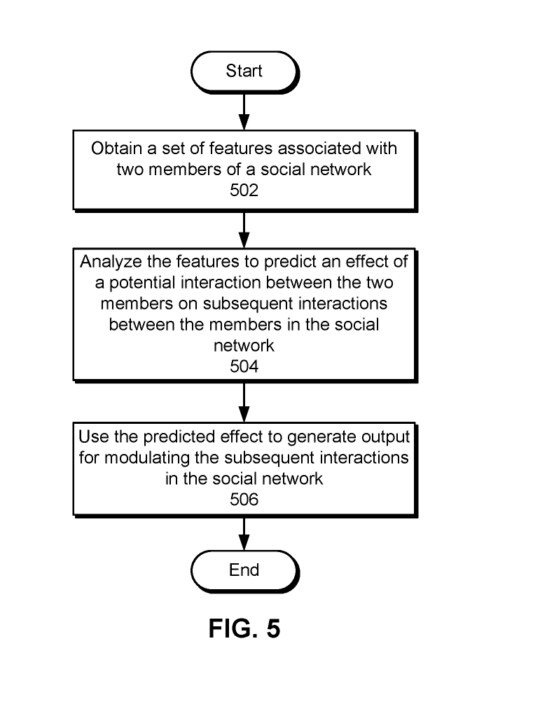

FIG. 5 shows a flowchart illustrating the process of improving interaction in a social network in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of features associated with two members of a social network is obtained (operation 502). The features may include member features such as a number of connections, a profile attribute, a job-seeking intent, and/or a tenure on the social network for each of the members. The features may also include activity features such as an activity level, a messaging activity, a publishing activity, a mobile activity, and/or an email activity for each member.

Next, the features are analyzed to predict an effect of a potential interaction between the two members on subsequent interactions between the members in the social network (operation 504). For example, one or more subsets of features may be provided as input to one or more statistical models, and the statistical model(s) are used to predict the effect of the potential interaction on different types of interaction (e.g., new connections, feed interactions, messaging interactions, profile views, etc.) in the social network.

Finally, the predicted effect is used to generate output for modulating the subsequent interactions in the social network (operation 506). For example, the predicted effect may be combined with an estimated probability of the potential interaction between the members to produce a score for the potential interaction. The potential interaction may then be ranked with other potential interactions by the score, and a highest-ranked subset of potential interactions from the ranking may be outputted to one or both members. Thus, a new connection and/or other type of potential interaction that produces a predicted increase in subsequent interactions between the members may result in the outputting of a recommendation to form the new connection and/or conduct the potential interaction. In another example, non-recommendation-based output may include the display of feed updates, profiles, reminders, and/or other content associated with the members to one another to encourage certain types of social network interaction between the members.

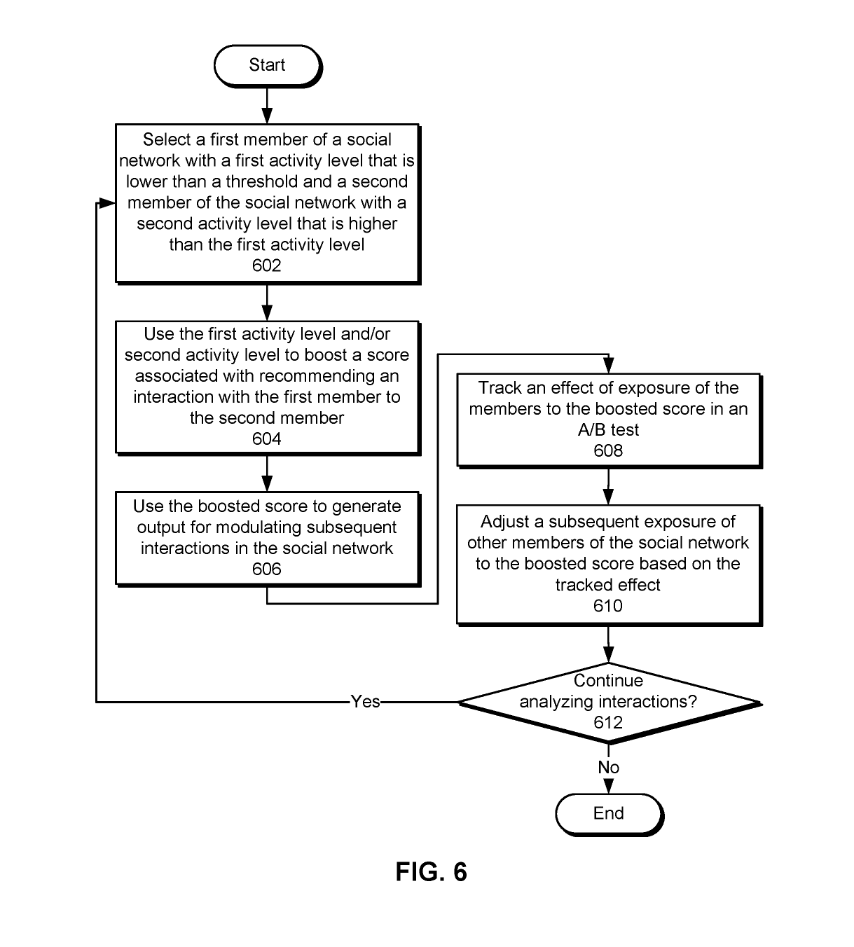

FIG. 6 shows a flowchart illustrating the process of using member activity levels to modulate subsequent interactions in a social network in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a first member of a social network with a first activity level that is lower than a threshold and a second member of the social network with a second activity level that is higher than the first activity level are selected (operation 602). For example, the first member may be a dormant user of the social network (e.g., the member has not accessed the social network for a pre-specified period), and the second member may be an active user of the social network (e.g., the member has accessed the social network within the pre-specified period). In another example, the first member may have an overall activity level that is characterized to be lower than the second member's. In a third example, both members may be selected for exposure to a treatment version in an A/B test. One or both members and/or the threshold may additionally be selected based on one or more member segments of the member(s).

Next, the first and/or second activity levels are used to boost a score associated with recommending, to the second member, an interaction with the first member (operation 604). For example, the score for recommending a new connection between the members may be scaled using weights associated with the first and/or second activity levels and/or numeric values representing the first and/or second activity levels.

The boosted score is then used to generate output for modulating subsequent interactions in the social network (operation 606). For example, the boosted score may be used to place the recommended interaction in a ranking of recommended interactions by the score, and a subset of the ranking may be outputted to the second member. Because the score is boosted for the recommended interaction, the recommended interaction may have a higher position in the ranking, which results in a greater likelihood of being seen by the second member.

An effect of exposure of the members to the boosted score is also tracked in an A/B test (operation 608), and a subsequent exposure of other members of the social network to the boosted score is adjusted based on the tracked effect (operation 610). For example, the effect may be measured as an increase in the activity level of the first member and/or a decrease in one or more types of interaction from the second member. Subsequent exposure to the boosted score may then be increased or decreased based on the benefits and/or costs associated with the measured effect.

Interactions in the social network may continue to be analyzed (operation 612) for the members and/or other pairs of members in the social network. For example, operations 602-610 may be repeated for additional members, types of interaction, member segments, and/or levels of activity in the social network. Conversely, such analysis may be discontinued if the effect of the analysis is determined to be too detrimental to subsequent member interactions and/or growth or use of the social network.

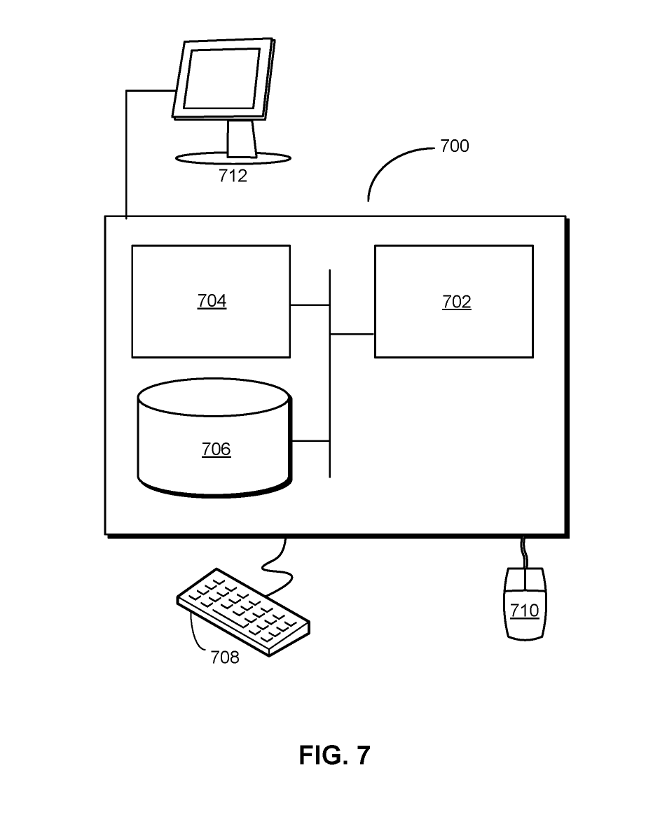

FIG. 7 shows a computer system 700. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating interaction within a social network. The system may include an analysis apparatus and a management apparatus, one or both of which may alternatively be termed or implemented as a module, mechanism, or other type of system component. The analysis apparatus may obtain a set of features associated with two members of a social network. Next, the analysis apparatus may analyze the features to predict an effect of a potential interaction between the two members on subsequent interactions between the two members in the social network. The management apparatus may then use the predicted effect to generate output for modulating the subsequent interactions in the social network.

The analysis apparatus may also, or instead, identify a first member of a social network with a first activity level that is lower than a threshold. Next, the analysis apparatus may use the first activity level to boost a score associated with recommending an interaction with the first member to a second member of the social network. The management apparatus may then use the boosted score to generate output for modulating subsequent interactions in the social network.

In addition, one or more components of computer system 700 may be remotely located and connected to the other components over a network. Portions of the present embodiments (e.g., analysis apparatus, management apparatus, statistical model, selection apparatus, data repository, etc.) may also be located on different nodes of a distributed system that implements the embodiments. For example, the present embodiments may be implemented using a cloud computing system that characterizes and manages interactions among members that access a social network through a set of remote electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
identifying a first member of a social network with a first activity level that is lower than a threshold;
using the first activity level to boost, by a computer system, a score associated with recommending an interaction with the first member to a second member of the social network; and
using the boosted score to generate output for modulating subsequent interactions in the social network.

2. The method of claim 1, further comprising:
using a second activity level of the second member to further boost the score.

3. The method of claim 2, wherein the second activity level is higher than the first activity level.

4. The method of claim 1, further comprising:
selecting the first and second members for exposure to the boosted score in an A/B test; and
tracking an effect of the exposure to the boosted score in the A/B test.

5. The method of claim 4, further comprising:
adjusting a subsequent exposure of other members of the social network to the boosted score based on the tracked effect.

6. The method of claim 4, wherein the effect comprises a change in the first activity level.

7. The method of claim 4, wherein the effect comprises a change in an amount of a type of interaction by the second member.

8. The method of claim 1, wherein obtaining the first member comprises:
selecting the first member and the threshold based on a member segment of the first member.

9. The method of claim 1, wherein using the first activity level to boost the score comprises:
scaling the score using a weight associated with the first activity level.

10. The method of claim 1, wherein using the boosted score to generate output for modulating subsequent interactions in the social network comprises:
ranking the recommended interaction and additional recommended interactions for the second member by the score; and
outputting a subset of the ranking to the second member.

11. The method of claim 1, wherein the recommended interaction comprises a recommendation to form a new connection between the first and second members.

12. An apparatus, comprising:
one or more processors; and
memory storing instructions that, when executed by the one or more processors, cause the apparatus to:
identify a first member of a social network with a first activity level that is lower than a threshold;
use the first activity level to boost a score associated with recommending an interaction with the first member to a second member of the social network; and
use the boosted score to generate output for modulating subsequent interactions in the social network.

13. The apparatus of claim 12, wherein the memory further stores instructions that, when executed by the one or more processors, cause the apparatus to:
use a second activity level of the second member to further boost the score.

14. The apparatus of claim 13, wherein the second activity level is higher than the first activity level.

15. The apparatus of claim 12, wherein the memory further stores instructions that, when executed by the one or more processors, cause the apparatus to:
select the first and second members for exposure to the boosted score in an A/B test;
track an effect of the exposure to the boosted score in the A/B test; and
adjust a subsequent exposure of other members of the social network to the boosted score based on the tracked effect.

16. The apparatus of claim 15, wherein the effect comprises at least one of:
a change in the first activity level; and
a change in an amount of a type of interaction by the second member.

17. The apparatus of claim 12, wherein obtaining the first member comprises:
selecting the first member and the threshold based on a member segment of the first member.

18. A system, comprising:
an analysis module comprising a non-transitory computer-readable medium comprising instructions that, when executed, cause the system to:
identify a first member of a social network with a first activity level that is lower than a threshold; and
use the first activity level to boost a score associated with recommending an interaction with the first member to a second member of the social network; and
a management module comprising a non-transitory computer-readable medium comprising instructions that, when executed, cause the system to use the boosted score to generate output for modulating subsequent interactions in the social network.

19. The system of claim 18, wherein the non-transitory computer-readable medium of the analysis module further comprises instructions that, when executed, cause the system to:
use a second activity level of the second member to further boost the score.

20. The system of claim 18, wherein the non-transitory computer-readable medium of the analysis module further comprises instructions that, when executed, cause the system to:
select the first and second members for exposure to the boosted score in an A/B test;
track an effect of the exposure to the boosted score in the A/B test; and
adjust a subsequent exposure of other members of the social network to the boosted score based on the tracked effect.
